(19) United States
(12) Patent Application Publication
(10) Pub. No.: US 2008/0141492 A1
(43) Pub. Date: Jun. 19, 2008

(54) Hinge capable of providing different friction forces

(75) Inventor: Shu-Mu Lin, Shulin City (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: SHIN ZU SHING CO., LTD., Shulin City (TW)

(21) Appl. No.: 11/640,655

(22) Filed: Dec. 18, 2006

(51) Int. Cl. E05D 11/10

(52) U.S. Cl. 16/330

(57) ABSTRACT

A hinge includes a first disk adapted to be integrally formed with the fixing bracket and having a through hole adapted to allow extension of the shank, at least one recess and at least one slope both formed on a side face of the first disk and a second disk having a centrally defined hole adapted for extension of the shank and at least one boss movable between the at least one recess and the at least one recess such that when the fixing bracket is pivotally moved relative to the securing bracket, different friction force is provided to adapt to a movement direction of the fixing bracket to the securing bracket.

### BACKGROUND OF THE INVENTION

1. Field of the Invention

The present invention relates to a hinge, and more particularly to a hinge capable of providing different friction forces to adapt to pivotal movement of the hinge.

2. Description of the Prior Art

A hinge is to provide friction force to two objects moving in relation to one another so that one object is able to pivotally move under the influence of the friction force. The most common object that requires a hinge is a laptop computer or a PDA (personal digital assistance), etc. Taking the laptop computer for example, if the laptop computer is to be used, the user activates the locking mechanism to slightly separate the screen from the base. Then the user is able to pivot the screen relative to the base.

After use, the user is again able to pivotally move the screen toward the base to allow the locking mechanism to secure the screen to the base. During the entire pivotal movement of the screen toward the base, the hinge provides the necessary friction force to protect the screen from damage caused from impact of the screen to the base.

In normal, it is required that the pivotal movement of the screen away from the base has to be fast so as to provide access of the screen to the user and the pivotal movement of the screen toward the base has to be slow so that the screen is protected. However, the currently available hinge provide the same force to the pivotal movement of the screen. That is, no matter the screen is moving away from or toward the base, the hinge can only provide the same friction force, which makes no difference in the screen pivotal movement and provides no satisfaction to meet the general requirement of moving the screen faster when the screen is moving away from the base and moving the screen slower when the screen is moving toward the base.

To overcome the shortcomings, the present invention tends to provide an improved hinge to mitigate the aforementioned problems.

### SUMMARY OF THE INVENTION

The primary objective of the present invention is to provide an improved hinge which is able to provide different friction force to adapt to movement of the hinge.

In order to accomplish the aforementioned objective, the hinge of the present invention includes a shank, a securing bracket, a fixing bracket, a first disk, a second disk, a spring combination, a friction disk assembly and a securing element. The first disk has a through hole through which the shank extends, two recesses oppositely defined in a side face of the first disk and two slopes each sandwiched between the two recesses. The second disk has two bosses formed on a side face of the second disk and facing the side face of the first disk such that the two bosses are able to move between the recesses and the slopes when the second disk is pivoted relative to the first disk. Due to the movement of the bosses between the recesses and the slopes, different friction forces are generated to adapt to pivotal movements of the second disk to the first disk.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the hinge of the present invention;

FIG. 2 is an exploded perspective view of the hinge of the present invention;

FIG. 3 is an exploded perspective view showing the first disk and the second disk of the present invention;

FIG. 4 is an exploded perspective view of the first disk and the second disk in an angle different from that of FIG. 3; and

FIG. 5 is a partially cross sectioned schematic side plan view showing movement of the two bosses between the two recesses and the two slopes.

### DETAILED DESCRIPTION OF THE PREFERRED EMBODIMENT

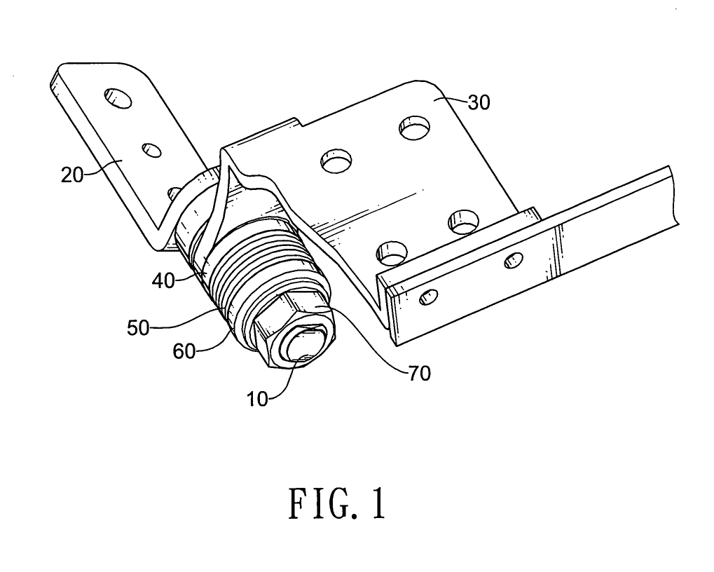

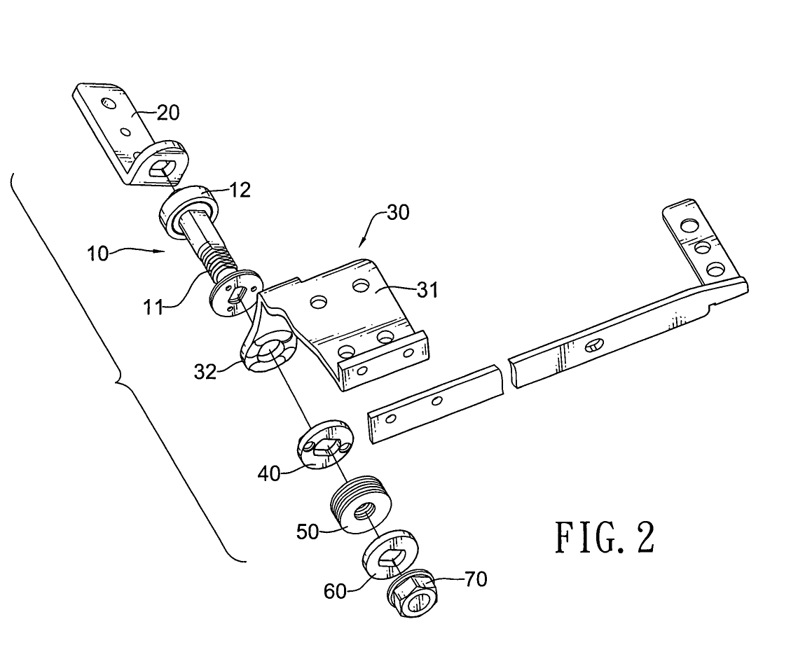

With reference to FIGS. 1 and 2, it is noted that the hinge in accordance with the present invention include a shank (10), a securing bracket (20), a fixing bracket (30) having a first disk (32) integrally formed therewith, a second disk (40), a spring combination (50), a friction disk assembly (60) and a securing element (70).

The shank (10) has a threaded end (11) and a crown (12) formed on the other end thereof. The securing bracket (20) is firmly attached to a surface of, such as, a base (not shown). The threaded end (11) of the shank (10) extends through a portion of the securing bracket (20) with the crown (12) on one side of securing bracket (20). The fixing bracket (30) has a fixing plate (31) capable of firmly attaching to a surface of, such as, a screen.

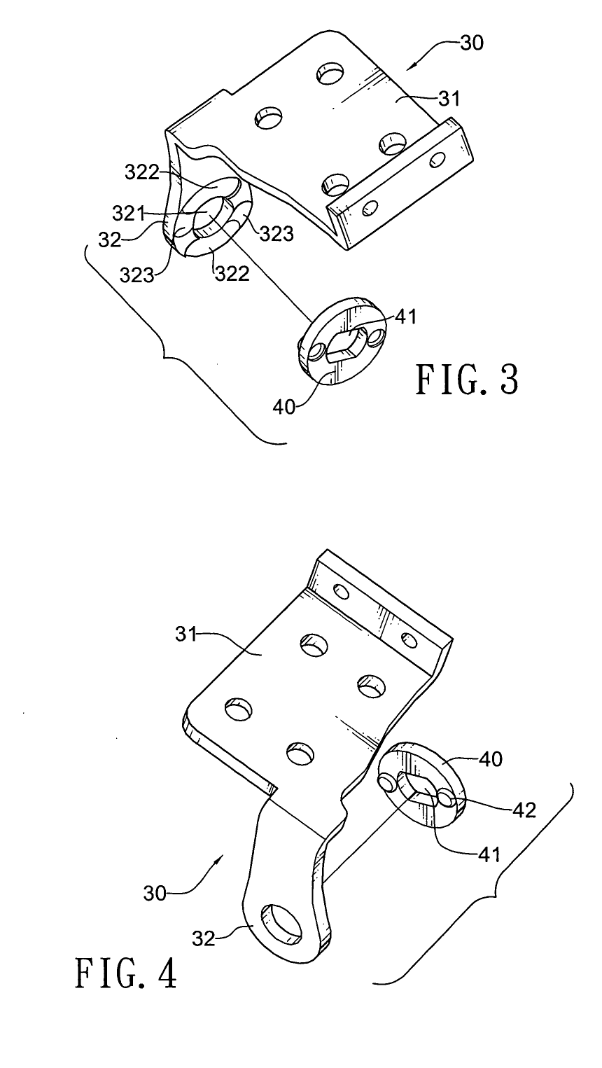

With reference to FIGS. 3 and 4, the first disk (32) has a through hole (321) defined to allow the threaded end (11) of the shank (10) to extend therethrough, two recesses (322) oppositely defined in a side face of the first disk (32) and two slopes (323) each sandwiched between the two recesses (322). Due to the formation of the slopes (323), thickness of each slope (323) is increased or decreased toward adjacent recess (322) depending what direction the measurement of the thickness is taken.

The second disk (40) has a centrally defined hole (41) which is so configured that after the threaded end (11) of the shank (10) extends, there is no relative movement between the shank (10) and the second disk (40). The second disk (40) further has two bosses (42) formed on a side face of the second disk (40) to correspond to the first disk (32) side face having the recesses (322) and the slopes (323) formed thereon. The threaded end (11) of the shank (10) further extends through the spring combination (50), the friction disk assembly (60) and into the securing element (70). The securing element (70) is preferably a nut such that the securing element (70) is able to securely fasten the friction assembly (60), the spring combination (50) and the second disk (40) on the shank (10).

After the hinge of the present invention is assembled, it is noted from FIGS. 1 and 2 that the second disk (40) is adjacent to the first disk (32) and when the fixing bracket (30) is pivoted relative to the securing bracket (20), the first disk (32) is pivoted relative to the second disk (40).

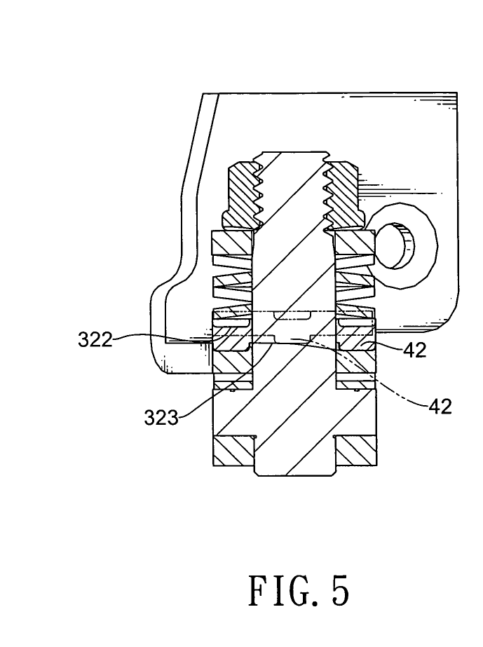

Furthermore, after the hinge is combined, the two bosses (42) are abutted to the two slopes (323) respectively. Therefore, when the fixing bracket (30) is pivoted relative to the securing bracket (20), i.e. the screen is pivoted relative to the base of a laptop computer to open the laptop computer, the two bosses (42) move from the slopes (323) to the recesses (322). That is, when opening the laptop computer is in process, the fixing bracket (30) is moving away from the securing bracket (20), the two bosses (42) moving from the two corresponding slopes (323) to the two recesses (322) results in that the user needs less force to complete the opening process when compared with a situation where the fixing bracket (30) is pivoted toward the securing bracket (20). It is because when the two bosses (42) are moving from the two recesses (322) to the two slopes (323), the user needs additional force to overcome the friction between the bosses (42) and the slopes (323). As a result, in a situation where the screen is opening relative to the base, because the two bosses (42) are moving from the two slopes (323) to the two recesses (322), little force is required to complete the process and in a situation where the screen is closing relative to the base, because the two bosses (42) are moving from the two recesses (322) to the two slopes (323), large force is required to overcome the friction between the two bosses (42) and the two slopes (323), as shown in FIG. 5.

As a result, the hinge of the present invention is able to provide different friction forces adaptive to the pivotal movement of the fixing bracket (30) to the securing bracket (20).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In a hinge having a securing bracket, a shank having a threaded end extending through the securing bracket to mount the shank on the securing bracket, a fixing bracket movably connected to the securing bracket in a first direction and a second direction, a spring combination securely mounted on the shank, a friction disk assembly securely mounted on the shank and a securing element securely connected to the threaded end of the shank to secure the friction disk assembly and the spring combination on the shank, wherein the improvement comprises:
a first disk is adapted to be integrally formed with the fixing bracket and has a through hole adapted to allow extension of the shank, at least one recess and at least one slope both formed on a side face of the first disk; and
a second disk has a centrally defined hole adapted for extension of the shank and at least one boss movable between the at least one recess and the at least one recess such that when the fixing bracket is pivotally moved in a first direction relative to the securing bracket, the at least one boss moves from the at least one slope to the at least one recess and the pivotal movement of the fixing bracket to the securing bracket is facilitated and when the fixing bracket is pivotally moved in a second direction relative to the securing bracket, the at least one boss moves from the at least one recess to the at least one slope and the pivotal movement of the fixing bracket to the securing bracket is hindered.

2. The hinge as claimed in claim 1, wherein there are two bosses formed on the side face of the second disk and there are two recesses and two slopes formed on the side face of the first disk.

3. The hinge as claimed in claim 2, wherein the two recesses, slopes and the bosses are respectively and oppositely formed.

4. The hinge as claimed in claim 2, wherein each of the two recesses is sandwiched between the two slopes.

5. The hinge as claimed in claim 3, wherein each of the two recesses is sandwiched between the two slopes.
